(19) United States
(12) Patent Application Publication
(10) Pub. No.: US 2024/0152177 A1
(43) Pub. Date: May 9, 2024

(54) CLOCK SIGNAL DISTRIBUTION METHOD

(71) Applicant: Telefonaktiebolaget LM Ericsson (publ), Stockholm (SE)

(72) Inventors: Alessandra BIGONGIARI, Volterra (IT); Stefano STRACCA, PIsa (IT)

(21) Appl. No.: 18/279,806

(22) PCT Filed: Mar. 2, 2021
(86) PCT No.: PCT/EP2021/055135

§ 371 Date: Aug. 31, 2023

(51) Int. Cl. G06F 1/10; G06F 1/08

(52) U.S. Cl. CPC G06F 1/105; G06F 1/08

(57) ABSTRACT

A clock signal distribution method and system. The clock signal distribution method includes transmitting an optical clock signal at a clock frequency via an optical waveguide, wherein the optical clock signal is transmitted separately from optical data transmissions. The method further includes receiving the optical clock signal at the same clock frequency using a photodetector and converting the optical clock signal into an electrical clock signal using the photodetector. The electrical clock signal has the same clock frequency as the optical clock signal. The method further includes transmitting the electrical clock signal at the clock frequency via an electrical connection.

### TECHNICAL FIELD

Embodiments described herein relate to a clock signal distribution method and system, in particular a clock signal distribution method and system for distribution of an optical clock signal.

### BACKGROUND

In current hardware units, such as packet switching equipment and antenna array systems of the type commonly used in telecommunications networks, high speed serial transmission is the most common way to implement high bandwidth data transmission. Modern integrated circuit (IC) manufacturing allows the creation and use of highly sophisticated serial to parallel/parallel to serial converters (commonly referred to as SerDes) that are able to manage signals at very high bit rates. The shift from parallel transmission to serial transmission means that circuit complexity can be shifted from a Printed Circuit Board (PCB) to a silicon chip (such as a SerDes), which can help reduce the impact of issues relating to high number of tracks on PCBs, skew control, electromagnetic interference, and so on. Multi-level transmission techniques such as Pulse Amplitude Modulation 4 (PAM4), in which multiple voltage levels can be used to represent combinations of logical bits, can be used to further increase the bandwidth per data transmission stream. One consequence of the use of high speed serial transmission and multi-level transmission techniques is the need for complex SerDes, typically using Digital Signal Processing (DSP) and Forward Error Correction (FEC) blocks even for short range electrical links. A discussion on the use of DSP and FEC in high speed electrical interfaces can be found in “Common Electrical I/O (CEI)—Electrical and Jitter Interoperability agreements for 6G+ bps, 11G+ bps, 25G+ bps I/O and 56G+ bps” by the Optical Internetworking Forum, OIF-CEI-04.0, available at https://www.oiforum.com/wp-content/uploads/2019/01/OIF-CEI-04.0.pdf as of 15 Feb. 2021.

In operation, serialization/de-serialization requires a unit at each end of a data transmission line. The transmission serializer acts to prepare data for serial transmission from a collection of parallel streams. At the receiver de-serializer the data are de-serialized into parallel streams. The de-serializer uses a reference clock to sample data at the same frequency as that used when the data was serialized for transmission; typically the reference clock may be retrieved from the data transmission. FIG. 1 is a schematic diagram of a typical serial communication link on a PCB, between a transmitter 10 and receiver 20. As shown in FIG. 1, a parallel data flow is serialized by means of a parallel-to-serial converter 11 that is clocked at the desired symbol rate (an example of a typical symbol rate is 25.78125 Gb/s as used in chip to chip transmissions for 100 Gbps Ethernet). A clock signal at the required frequency is provided to the parallel-to-serial converter 11 via a transmission phase locked loop (PLL) 12. The PLL generates the clock signal at the required frequency from a reference clock signal, typically by multiplying the reference clock frequency. A TX driver 13 generates the proper waveform for PCB transmission, with adequate voltage swing and possible signal conditioning to counteract copper line attenuation at high frequencies. At the other end of the PCB transmission line is the receiver 20, including an analog front-end 21 that amplifies and equalizes the signal to compensate for attenuation and linear distortion introduced by the transmission line. As the clock information is contained in the received data, a clock and data recovery block 22 is needed to extract the clock. A phase interpolator 23; which adjusts the phase of sampled clock signals in fine increments, is needed to find the best sampling point for the serial to parallel conversion (performed by the serial-to-parallel converter 24) that recreates the original parallel data flow.

The reference clock signal for a system is a periodic signal at a given frequency (the reference clock frequency) that is used to maintain timing synchronization across the system. A circuit that use a clock signal becomes active at the clock rising edge, falling edge or both. A clock signal for a circuit may be at a different frequency to a reference clock signal; as explained with reference to FIG. 1 above, one or more PLLs may be used to obtain a clock signal at a desired frequency by performing operations (such as multiplying operations) on the reference clock signal. If the signal is multiplied (or divided, or the frequency altered by some other operation) before being used, the clock signal is the result of the multiplication (division or other operation), not the reference clock signal.

In order to provide reliable high-speed serial communication it is necessary to provide a clock signal with very low mistiming, as the time margins to correctly sample data at the receiver are extremely narrow. Mistiming inside transmission equipment occurs when data is regenerated and may cause the production of errors. Even at low values of mistiming, sensitivity to amplitude and phase variations is increased. In existing systems, such as that shown in FIG. 1, the transmitted data signal is generated with a clock signal that is not provided directly at the chip's pin but is provided by a PLL. The PLL generates a clock at the transmission symbol frequency (for example, 25.71825 GHz as discussed above) starting from a reference clock signal that is provided at the PLL input. Typically, the reference clock frequency is in the 100's of MHz range, therefore it is necessary to multiply the reference clock frequency in order to obtain a clock signal at the transmission frequency. The multiplication of the reference clock frequency results in the multiplication of any mistiming present in the reference clock. Depending on the frequency band of the mistiming, it may be referred to as wander or jitter.

FIG. 2 is a diagram illustrating the effect of jitter on a transmitted signal, which is adapted from FIG. 1.1 of “Understanding Jitter and Wander Measurements and Standards”, 2^{nd} edition, by Agilent Technologies, available at http://literature.cdn.keysight. com/litweb/pdf/5988-6254EN.pdf as of 15 Feb. 2021. Jitter can be generally defined as phase noise at a frequency above 10 Hz, while wander is phase noise at a frequency below Hz. Jitter can result in interference and/or noise, which can prevent correct sampling and ultimately results in bit errors. Even where jitter does not directly result in errors, it may reduce the noise margin of the system and thereby make the system more prone to errors. To some extent, jitter is always present within devices, systems and networks. In order to ensure interoperability between devices and minimize signal degradation due to jitter accumulation across long distances, system specifications typically include limits on the maximum level of jitter present at an output interface and the maximum level that can be tolerated at an input.

A further potential source of errors is wander. As explained above, wander is the generic term for the slow and very slow timing fluctuations affecting transmission networks. Mistiming with a periodicity below 10 Hz is considered wander. PLLs may be used when recovering a clock signal at a receiver, as this can help to remove noise and provide a “clean” clock signal. The use of a PLL when recovering a clock signal can introduce a low frequency phase variation in the recovered clock, that is, can introduce wander. To prevent bit slips due to wander, data are buffered. If the wander gets too large, buffers will either overflow or underflow causing loss or repetition of data. Additionally, buffering implies latency, so in time critical communications (such as those that may be found in radio and/or industrial systems) it is desirable to keep buffering to a minimum.

As explained above, the multiplication of jitter when the transmission symbol frequency is obtained from the reference clock frequency is a potential source of errors. Once obtained, the routing of the transmission symbol frequency both in the PCB and inside the chip is restricted; the high frequency used for the transmission symbol frequency means that the electrical signal used to transmit the transmission symbol frequency can only be distributed over short distances. It is therefore often necessary to transmit the (lower frequency) reference clock frequency to components, and then generate the transmission symbol frequency at the components using one or more PLLs. Typically, a single PLL cannot feed more than 4 SerDes inside the same chip, and for some applications cascades of PLLs are required in order to provide signals for distribution; this can result in substantial costs due to the expense of providing multiple PLLs. Moreover, the PLLs can contribute significantly to SerDes overall power consumption; “A 28 Gb/s 560 mW Multi-Standard SerDes with single-stage analog Front-end and 14-tap decision feedback equalizer in 28 nm CMOS” by H. Kimura et al (available at https://ieeexplore.ieee.org/document/6894632 as of 3 Feb. 2021) found that a single PLL accounts for approximately 6% of the total power consumption of the SerDes system (including transmission and reception portions) that is the subject of that document.

On the receiver side, the clock signal is typically extracted from the incoming data stream using a dedicated Clock and Data Recovery (CDR) block, as shown in FIG. 1. The CDR block is used to recover the transmitted clock frequency and find the best sampling point for the received signal. Clock recovery also accounts for a substantial portion of the power consumption contributor of a SerDes receiver; CDRs use high toggling rate parallel sampling registers and analog circuits, which require substantial power. CDR blocks also typically require a more complex or separate equalizer to a standard data recovery equaliser, as a standard data recovery equaliser is typically not optimized for clock recovery, again increasing power consumption. Further, and as discussed above, use of PLLs in CDR blocks can also introduce wander into recovered clock signals.

The issues surrounding phase noise multiplication and clock reconstruction become progressively challenging at increasing data rates. High frequency electrical signals suffer from losses caused by skin effect, weave effects, surface roughness, vias, and connectors. Receivers can typically detect incoming signals as low as 38 dB below the signal amplitude at the transmitter; this sensitivity can make receivers more prone to crosstalk as they are more susceptible to interference from a signal leaving the transmitter at full amplitude. Issues around crosstalk and interference can limit the achievable transmission length of the electric clock signal.

### Summary

It is an object of the present disclosure to provide methods and devices for clock signal distribution which at least partially address one or more of the challenges discussed above. In particular, it is an object of the present disclosure to provide methods and devices for clock signal distribution that are less susceptible to jitter and wander, and that can provide useable signals over extended transmission lengths.

The present disclosure provides a clock signal distribution method. The method comprises transmitting an optical clock signal at a clock frequency via an optical waveguide, wherein the optical clock signal is transmitted separately from optical data transmissions. The method further comprises receiving the optical clock signal at the same clock frequency using a photodetector, and converting the optical clock signal into an electrical clock signal using the photodetector, wherein the electrical clock signal has the same clock frequency as the optical clock signal. The method also comprises transmitting the electrical clock signal at the clock frequency via an electrical connection. Use of optical clock signals for clock signal distribution may allow distribution of higher frequency clock signals with lower susceptibility to jitter, wander and electromagnetic interference.

The optical clock signal may be used at the clock frequency by an electronic component, which may be a serializer/deserializer (SerDes). The high frequencies which can be distributed effectively using the optical clock signal may be particularly beneficial for use with modern SerDes modules.

The optical clock signal may be transmitted via the optical waveguide over a distance that is at least 10 times larger than the distance over which the electrical clock signal is transmitted via the electrical connection. In this way, the distance over which the electrical clock signal is transmitted can be reduced relative to prior systems, so the susceptibility to noise sources that impact electrical clock distribution is correspondingly reduced.

The optical clock signal may be generated by an optical transceiver, which may be connected to one or more further optical transceivers via optical waveguides, wherein the further optical transceivers may each receive the optical clock signal. In this way a single optical clock signal can be distributed to a number of different locations, and use of existing hardware may help minimise costs.

The present disclosure also provides a clock signal distribution system for distributing an optical clock signal. The clock signal distribution system comprises an optical clock signal transmitter and an optical clock signal receiver. The optical clock signal transmitter is configured to transmit an optical clock signal at a clock frequency via an optical waveguide, wherein the optical clock signal is transmitted separately from optical data transmissions. The optical clock signal receiver is configured to receive the optical clock signal at the same clock frequency using a photodetector and convert the optical clock signal into an electrical clock signal using the photodetector, wherein the electrical clock signal has the same clock frequency as the optical clock signal. The optical clock signal receiver is further configured to transmit the electrical clock signal at the clock frequency via an electrical connection. The clock signal distribution system may provide analogous benefits to the clock signal distribution method as discussed above.

### BRIEF DESCRIPTION OF DRAWINGS

The present disclosure is described, by way of example only, with reference to the following figures, in which:

FIG. 1 is schematic diagram of a typical serial communication link on a PCB;

FIG. 2 is a diagram illustrating the effect of jitter on a transmitted signal;

FIG. 3 a schematic overview of a system implementing a clock distribution method in accordance with an aspect of an embodiment;

FIG. 4A and FIG. 4B are schematic diagrams of optical transceivers which may be used for the generation and transmission of optical clock signals in accordance with aspects of embodiments;

FIG. 5 is a flowchart showing a clock distribution method according to aspects of embodiments;

FIG. 6A and FIG. 6B are schematic diagrams showing clock signal transmitters in accordance with aspects of embodiments;

FIG. 7A and FIG. 7B are schematic diagrams showing clock signal receivers in accordance with aspects of embodiments; and

FIG. 8 is a schematic diagram of a system for transmitting/receiving an optical clock signal in accordance with aspects of embodiments.

FIG. 9A and FIG. 9B are schematic diagrams showing example implementations of clock signal distribution in accordance with aspects of embodiments

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

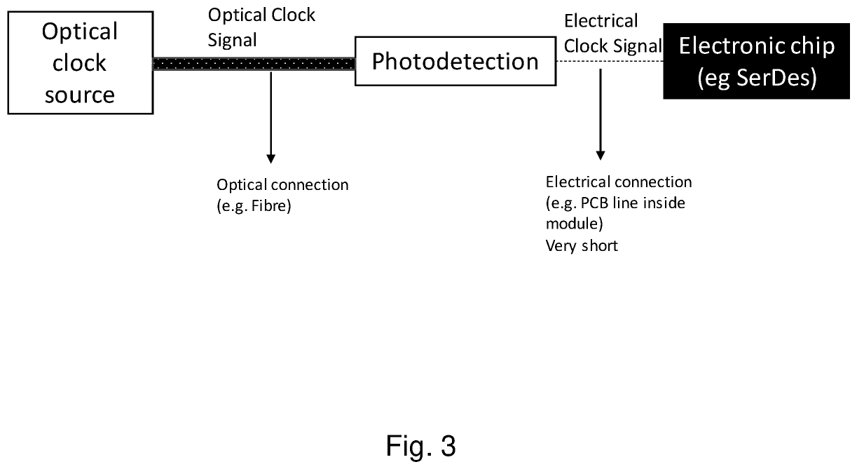

Aspects of embodiments provide clock signal distribution (for example, from an optical clock generator to one or more electronic components that may use the clock signal) through the use of optical clock signals. The optical clock signals may be generated using a light source (such as a laser or laser diode) in conjunction with a signal modulator (such as an electro-optic or acousto-optic modulator) distributed through one or more optical waveguides (such standard or polymeric optical fibres, which may be single-mode or multi-mode optical fibres, graded index waveguides, and so on) and received using a photodetector (such as a photodiode, metal-semiconductor-metal (MSM) photodetector, graphene based photodetector, and so on). FIG. 3 is a schematic overview of a system implementing a clock distribution method in accordance with an aspect of an embodiment. As can be seen in FIG. 3, the optical clock signal is generated at an optical clock source and then distributed via an optical carrier sent on an optical connection such as a fibre optic. The optical carrier has a combination of optical properties (such as wavelength, phase, and so on) and is used to convey a signal. Different optical carriers using the same optical connection have optical properties that differ in some way, for example, the optical carriers may use different wavelengths. The optical connection may be used to transmit the optical clock signal to a photodetector in close proximity to the intended destination of the clock signal; optical signals are low loss and immune to electromagnetic interference issues that can result from transmission of electrical clock signals over longer distances. The optical clock signal is then recovered at the photodetector, and transmitted over an electrical connection to an electrical component such as a SerDes or other chip. In some aspects of embodiments, the electrical connection is part of the electrical component. The electrical component that uses the clock signal (at the clock frequency) typically becomes active at (i.e. uses) the rising edge, falling edge or both of the recovered clock signal. In order to avoid loss and electromagnetic interference issues, the electrical connection may be configured to be as short as possible. Optical clock distribution systems in accordance with aspects of embodiments may be implemented in any system requiring a reliable clock signal, particularly where the clock signal uses a high frequency. As an example implementation, optical clock generation may be implemented in an Extremely High Frequency (EHF) radio signal system, wherein radio frequencies in the range of 30 to 300 GHz are used. By way of further example, optical clock signals may be implemented in data centres, nodes of telecommunication systems (such as core network nodes and base stations), and so on.

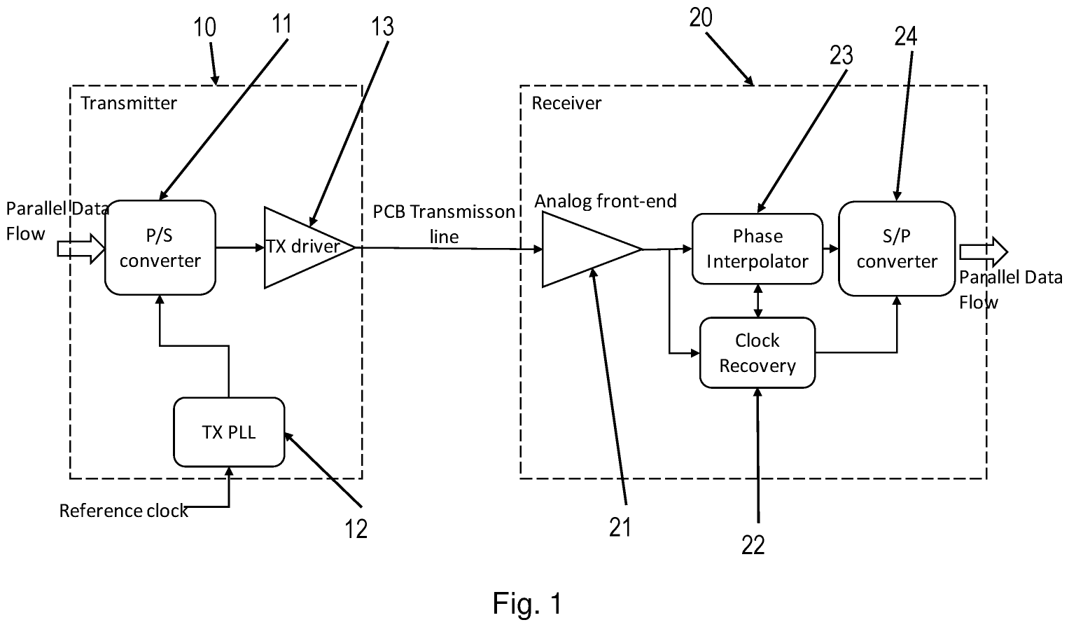

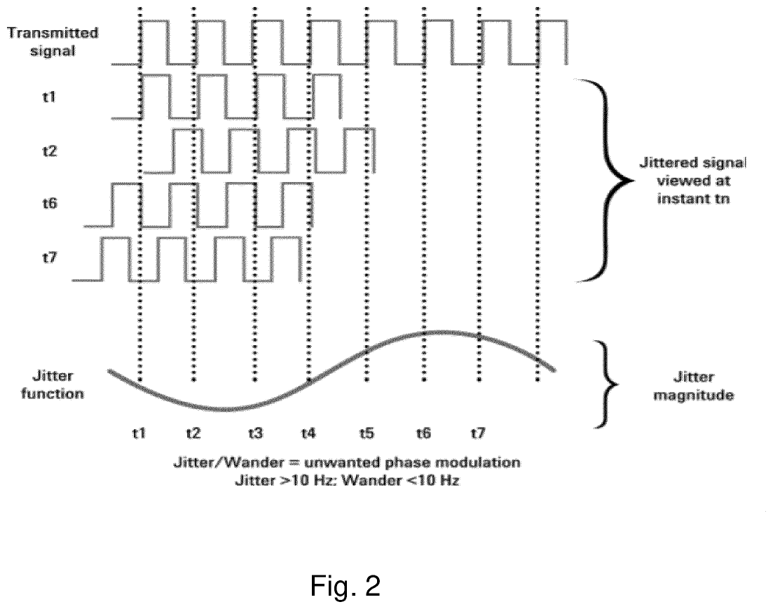

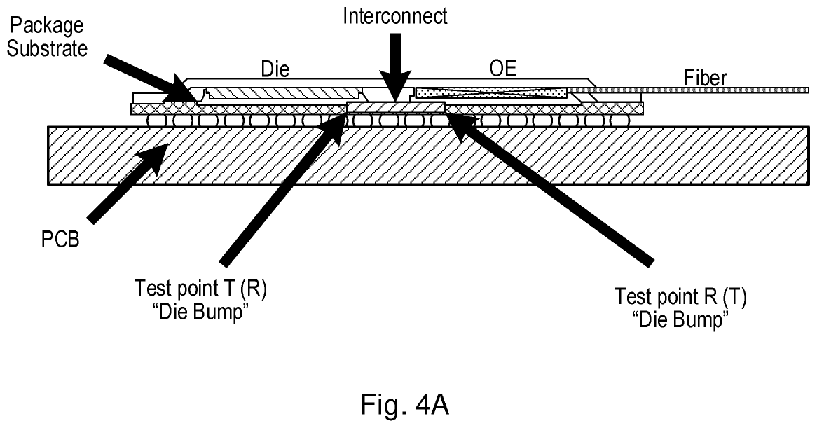

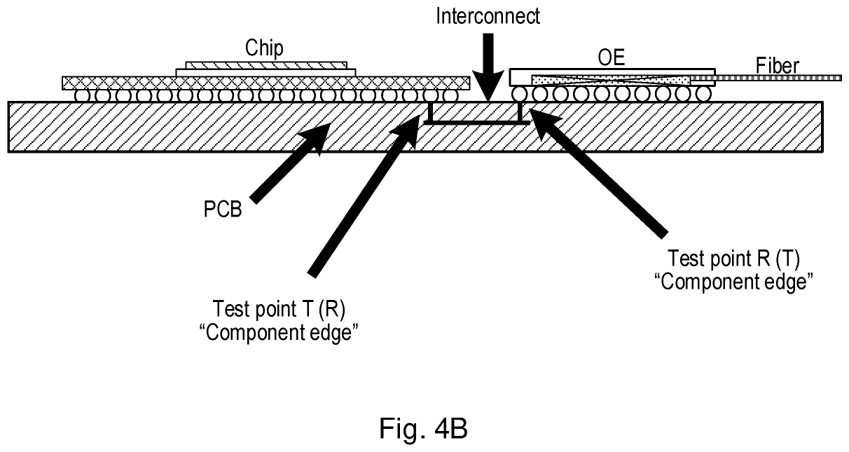

Prior to transmission the optical clock signal is obtained. The optical clock signal may be generated in the same chip that transmits the optical clock signal, for example, an optical transceiver may be used to both generate (using a signal generator) and transmit the optical clock signal. Alternatively, the optical clock signal may be obtained from a source separate from the chip responsible for transmission of the clock signal, and received by the chip using a receiver prior to transmission of the clock signal. FIG. 4A and FIG. 4B both show schematic diagrams of optical transceivers which may be used for the generation and transmission of optical clock signals in accordance with aspects of embodiments. Optical transceivers are increasingly included in multi-chip modules (such as those used in digital front ends, DFEs), which commonly include an optical interface electrically interconnected to a digital Application Specific Integrated Circuit (ASIC) or Field-Programmable Gate Array (FPGA) chip. FIG. 4A and FIG. 4B are modified from FIGS. 18-1 and 19-1 respectively of “OIF-CEI-04.0—Common Electrical I/O (CEI)— Electrical and Jitter Interoperability Agreements for 6G+ bps, 11G+ bps, 25G+ bps I/O and 56G+ bps” by the Optical Internetworking Forum, available at https://www.oiforum.com/technical-work/implementation-agreements-ias/ as of 4 Feb. 2021. FIG. 4A and FIG. 4B show example standard electrical interfaces for ultra short reach (USR) and extra short reach (XSR) interfaces respectively, which are commonly used for connections between chips. Both standard electrical interfaces may be used to connect an ASIC with optical transceivers including laser sources and photonic blocks (which can perform the function of transferring clock information to an optical carrier), and photodetectors that can receive an optical clock and convert the clock information into an electrical signal. As such, some or all of the hardware necessary to provide an optical clock signal in accordance with aspects of embodiments may be present in several standard interfaces.

The optical clock signal can be generated by using a signal generator such as a modulator to introduce a beat signal into a property (such as the phase, amplitude, polarisation, and so on) of an optical source. As explained above, the optical source may be a laser, a laser diode, or any other suitable optical source. Various different types of modulator may be used to provide the optical clock signal. Electro-optic modulators, in which a signal controlled element is used to modulate light from a light source, may be particularly well suited to this purpose. Various types of electro-optic modulators may be used, including electro-absorption modulators, interferometric modulators as Mach-Zehnder modulators, resonance modulators such as ring modulators, Franz-Keldysh modulators, plasmonic modulators, and so on. Other types of modulators such as acousto-optic modulators and magneto-optic modulators may also be suitable for use in some aspects of embodiments. In some aspects of embodiments comb generators, which generate harmonics of an input signal, or mode locked lasers, or paired optical sources operating in an injection locking process, may be used to generate the optical clock signal. Those skilled in the art will be aware of various means by which a clock signal may be introduced into light generated by an optical source, and will therefore be able to select a suitable combination of optical source and modulator for a given aspect of an embodiment.

The optical clock signal may be at the same frequency as the reference clock signal, that is, the reference clock signal may be generated at the required frequency. Since the optical clock signal has the same frequency as the electrical clock signal that is used in the electronic chip it is typically not necessary to perform any operation on the frequency of the received signal (such as multiplication operations) to obtain the clock signal of the electronic chip. As such, the optical transmitted clock signal is considered to have a frequency which is used directly. Through the avoidance of operations on the received signal, one potential source of jitter which may impact clock signals distributed electrically (that is, the use of PLLs, potentially in cascades of PLLs, for multiplication of reference signals) may be eliminated. Even in situations where operations are performed on the reference clock signal before transmission (such as multiplications of an electrical signal to feed the modulator driver) to obtain the optical clock signal, the number of operations required (and hence resulting jitter) is substantially reduced in comparison to prior clock distribution systems.

Optical signals, even those at high frequencies, may be transmitted over substantial distances without substantial signal integrity losses; this is not the case for high frequency electrical signals where electromagnetic interference and signal degradation issues limit the useful range over which high frequency electrical signals may be usefully transmitted. Although the optical clock signal may be generated at lower frequencies where useful for a particular implementation, typically the optical clock signal is generated at higher frequencies in the range of 20 GHz to 200 GHz. In particular, frequencies between 90 GHz and 110 GHz may be used. Frequencies in the stated ranges may be of particular use where the clock signal is used for clocking data transmissions, for example on a serial link (where the clock signal may be used by serializers, deserializers and/or SerDes). Further examples of use case include in optical interconnects for radio systems, wherein clock frequencies in accordance with aspects of embodiments may be used in systems using Common Public Radio Interface (CPRI) or enhanced CPRI (eCPRI) interfaces. These types of interfaces may be used, for example, in 3^{rd} Generation Partnership Project (3GPP) 5^{th} Generation (5G) systems; in connections between modules performing Fast Fourier Transforms (FFT) and modules performing Digital Beamforming (DBF), and in connections between Baseband Units (BBU) and Radio Units (RU). As such, the optical clock signal may be used in a radio communication system, e.g. in a radio base station or between parts of a radio base station. Where high data bandwidth requirements necessitate the use of parallel data links using Wavelength Division Multiplexing (WDM), the same clock signal may be utilised for a plurality of the parallel links.

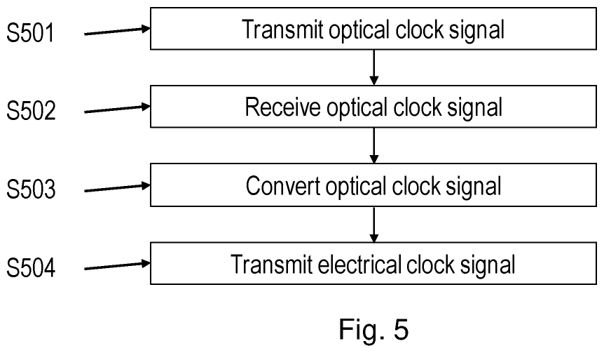

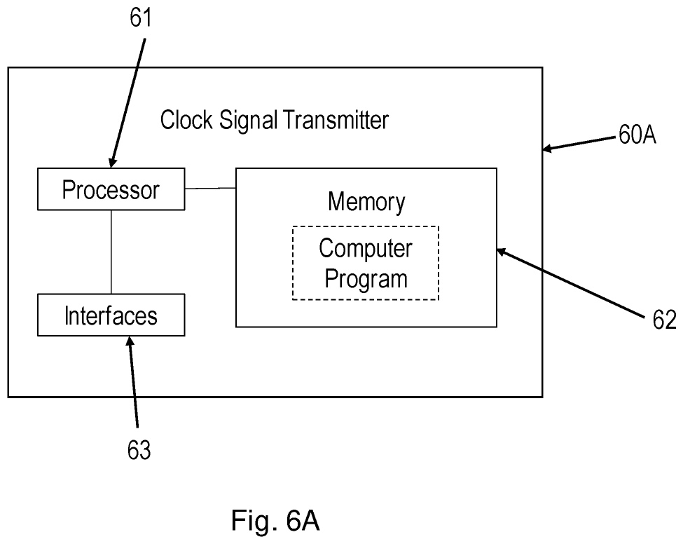

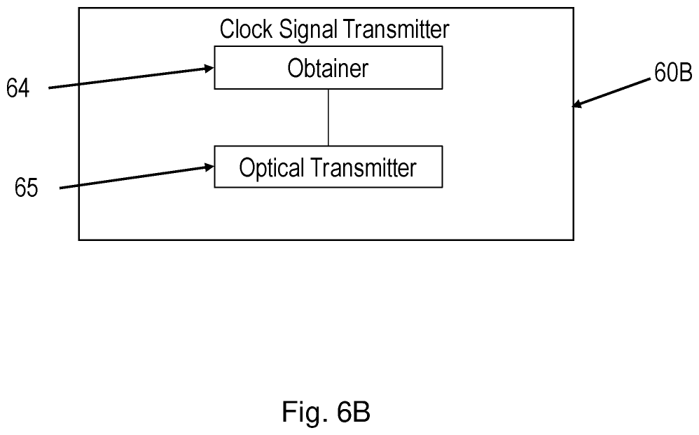

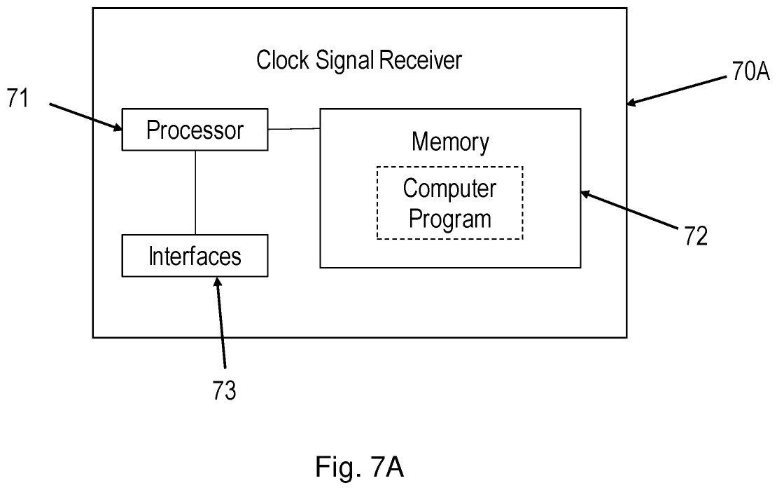

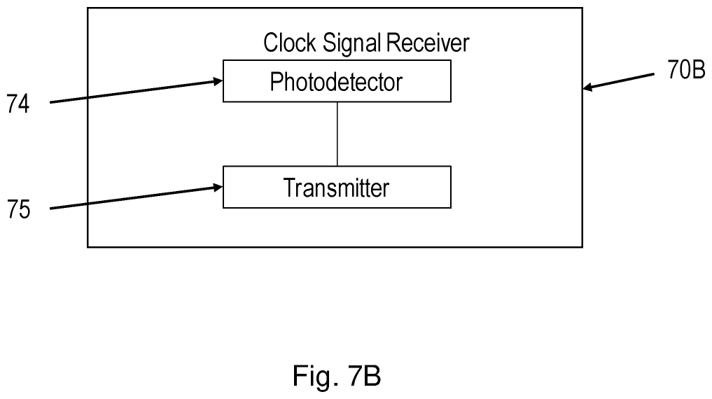

FIG. 5 is a flowchart showing a clock distribution method according to aspects of embodiments. FIG. 6A and FIG. 6B are schematic diagrams showing clock signal transmitters 60A, 60B in accordance with aspects of embodiments. The clock signal transmitters 60A, 60B may perform the method of FIG. 5. Further, FIG. 7A and FIG. 7B are schematic diagrams showing clock signal receivers 70A, 70B in accordance with aspects of embodiments. The clock signal receivers 70A, 70B may perform methods such as the method according to aspects of embodiments that is shown in the flowchart of FIG. 5.

In step S501 of the FIG. 5 method, the clock signal transmitter 60A, 60B transmits an optical clock signal at a clock frequency via a waveguide (for example, an optical fibre). The transmission of the optical clock signal may be performed, for example, by the clock signal transmitter 60A in which the processor 61 runs a program stored on the memory 62 and utilises the interfaces 63 (which may include a light source such as a laser) to transmit the optical clock signal, or may be performed by the transmitter 65 of optical transmitter 60B. Where the optical clock signal is obtained before transmission, this obtaining may be performed, for example, by the processor 61 of clock signal transmitter 60A running a program stored on the memory 62 and utilising the interfaces 63, or may be performed by the obtainer 64 of optical transmitter 60B (as explained above, this may be an electrical signal generator or an electrical signal receiver).

The optical clock signal is transmitted separately from optical data transmissions. As such, the clock signal is not integrated with the data, e.g. the clock signal is not part of a frame structure including both data and a clock signal. In some aspects of embodiments the optical clock signal is transmitted on the same waveguide as optical data transmissions, using an optical carrier having a different wavelength to those used by the optical data transmissions. Where the optical clock signal and optical data transmissions use the same waveguide, typically the optical carriers for the optical clock signal and optical data transmissions are split before being detected at different photodetectors (for example, photodiodes). In other aspects of embodiments the optical clock signal and optical data transmissions may use different waveguides; there may be a waveguide which is used exclusively for the optical clock signal. Any suitable waveguides may be used, including standard fibres, polymeric fibres and graded index waveguides as discussed above. Where the transmitter and receiver are located within an integrated circuit or on the same circuit board, the waveguide may be embedded in the integrated circuit or board. Where the transmitter and receiver are located on different circuit boards (which may be located in the same piece of equipment or adjacent pieces of equipment), the waveguide bridges any gap between the circuit boards.

In step S502 the optical clock signal is received, at the same clock frequency at which the optical clock signal was transmitted, by a photodetector. The photodetector may be any device suitable for converting light into electricity; typically a photodiode is used but other devices such as metal-semiconductor-metal (MSM) or graphene based photodetectors may also be used in some implementations. Typically, although not invariably, the photodetector is used exclusively to receive the optical clock signal. In addition to being transmitted to a single receiver, the optical clock signal may also be distributed to a number of receivers (photodetectors) within a single chip or board, or on multiple boards located proximate to one another. As discussed above, one or both of the transmitter and receiver may form part of an optical transceiver. The reception of the optical clock signal may be performed, for example, by the clock signal receiver 70A in which the processor 71 runs a program stored on the memory 72 and utilises the interfaces 73 (which may include a photosensor such as a photodiode) to receive the optical clock signal, or may be performed by the photodetector 74 of clock signal receiver 70B.

As the optical clock signal is essentially immune to electromagnetic interference issues, and substantially less prone to signal degradation issues than electrical signals of equivalent frequency, the optical clock signal may be transmitted safely over tens of meters. However, typical applications of the optical clock signal (for example in Extremely High Frequency, EHF, radio signal generation systems) require transmission in the range of a few cm up to 1 m.

The received optical clock signal is converted, by the photodetector, at step S503 into an electrical clock signal at the same clock frequency as the optical clock signal. The conversion of the optical clock signal into an electrical clock signal may be performed, for example, by the clock signal receiver 70A in which the processor 71 runs a program stored on the memory 72 and utilises the interfaces 73 (which may include a photosensor such as a photodiode) to convert the optical clock signal, or may be performed by the photodetector 74 of clock signal receiver 70B. As the optical clock signal can be transmitted over far longer distances while remaining useful than an electrical clock signal of equivalent frequency, the photodetector is commonly located as close to the electronic component requiring the clock signal as possible, such that the length of the electrical connection from the photodetector to the electronic component requiring the clock signal can be minimised. In some aspects of embodiments, the electrical connection forms part of an electrical/electronic component. The electrical clock signal outputted by the photodetector is ideally transmitted over distances of the order of 50 mm or less. The optical clock signal is commonly transmitted via the optical waveguide over a distance that is at least 10 times larger than the distance over which the electrical clock signal is transmitted via the electrical connection. The optical clock signal may be directly detected using a photodetector. The optical clock signal does not require regeneration before detection by a photodetector.

Once the electrical clock signal (at the same frequency as the optical clock signal) has been obtained, this electrical clock signal is then transmitted via an electrical connection to an electronic component (see step S504). The electronic component may then make use of the electrical clock signal. Any electronic component that requires the clock signal may be the ultimate destination of the signal; an example of a component that may require the clock signal is the deserialization portion of a SerDes system. The transmission of the electrical clock signal may be performed, for example, by the processor 71 of clock signal receiver 70A running a program stored on the memory 72 and utilising the interfaces 73, or may be performed by the transmitter 75 of clock signal receiver 70B. As the distance over which the electrical clock signal is sent is minimised the electrical clock signal can be used at a chip without further processing; typically no regeneration of this signal is required before use. As such, aspects of the present application relate to using the frequency of the transmitted optical clock signal without any intermediate processing of the frequency. This is as opposed to systems using entirely electrical clock signals, in which amplifiers may be required in order to allow the electrical clock signal to be transmitted between chips and/or between boards. Further, in systems using entirely electrical clock signals, even where the electrical clock signal is amplified between source and destination, the electrical clock signal will typically require regeneration, utilising further PLLs, before use. As explained above, use of PLLs to regenerate a received electric clock signal to provide a clean signal for use can introduce wander into the signal. Regeneration is commonly required due to the impact of noise sources such as electromagnetic interference and thermal noise on the electronic clock signal during transmission; optical clock signals are not susceptible to electromagnetic interference, and typically do not require regeneration.

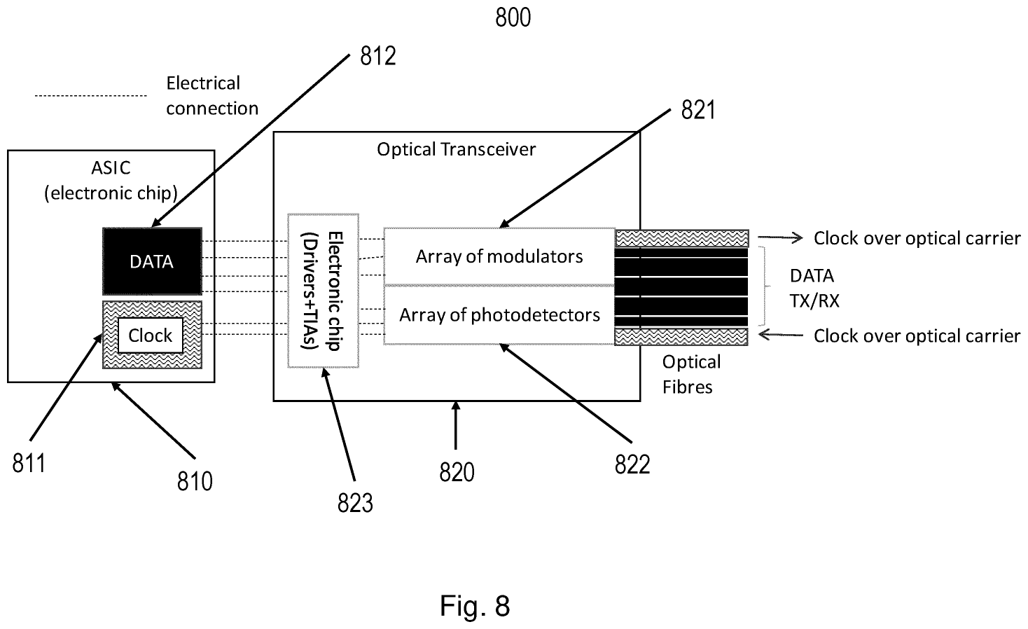

As explained above, in some aspects of embodiments the components used for optical clock signal distribution may also be utilised for other purposes. FIG. 8 is a schematic diagram of a system 800 for transmitting/receiving an optical clock signal in accordance with aspects of embodiments. In the system 800 of FIG. 8, the source of the clock signal (if acting as the transmitter) or destination of the clock signal (if acting as the receiver) is the ASIC 810, specifically the clock block 811 of the ASIC 810. Also shown in FIG. 8 is the data block 812 of the ASIC, responsible for generating/receiving data signals. The data and clock signals from the ASIC 810 are transmitted over short (of the order of a few mm) electrical connections to an optical transceiver 820. As shown in FIG. 8, the data and clock signals may be processed using an electronic chip 823 in the optical transceiver 820, wherein the electronic chip may comprise drivers used to provide the electrical signal to an array of modulators 821 with suitable characteristics for use by the modulators. The electronic chip may further comprise trans impedance amplifiers (TIAs) used to receive electric current from an array of photodetectors 822 and convert this current into voltage.

In the optical transceiver, the array of modulators 821, of any suitable type as discussed above, is used to convert the electrical signals from the ASIC 810 into outgoing optical signals for transmission, where the outgoing signals may include data signals and an optical clock signal. The optical clock signal is transmitted separately to the data signals; in the aspect of an embodiments shown in FIG. 8 the output optical clock signal is transmitted on a different fibre to the data signals, but in different aspects of embodiments the optical clock signal may be transmitted on the same fibre as a data signal using a different optical carrier to the data signal.

The array of photodetectors 822, again of any suitable type as discussed above, is used to receive incoming optical signals and convert the optical signals into electrical signals, where the incoming signals may include data signals and an optical clock signal. In the system 800 shown in FIG. 8, the optical clock signal is received on a separate fibre to the optical data signals; in alternative systems the optical clock signal may be received on the same fibre as a data signal using a different optical carrier to the data signal, and may be split from the data signal before reaching a photodetector. The electrical signals generated by the array of photodetectors 822 are then transmitted over short electrical connections to the ASIC 810.

In aspects of embodiments such as that shown in FIG. 8, the system 800 may be configured to both send and receive optical clock signals; in alternative aspects of embodiments, the system may be configured only to transmit or to receive the optical clock signal. The optical clock signal may be shared among co-packaged modules; for example there could be one single module with clock generation functionality that provides the optical clock signal to the other modules or the optical clock signal may come from a remote source.

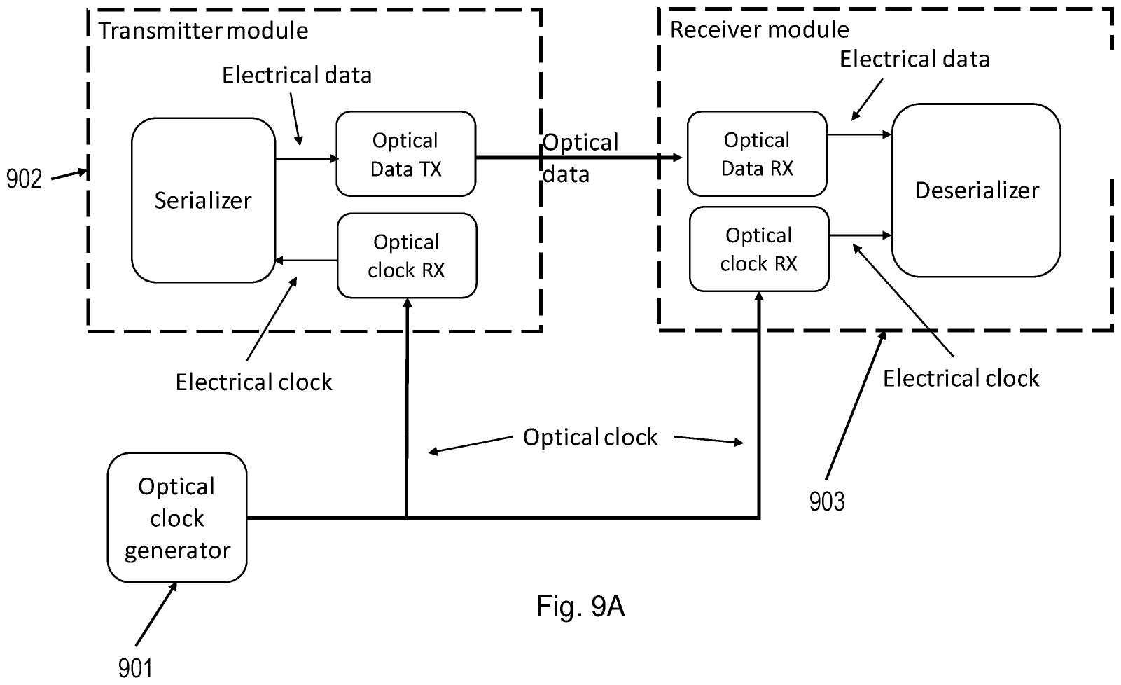

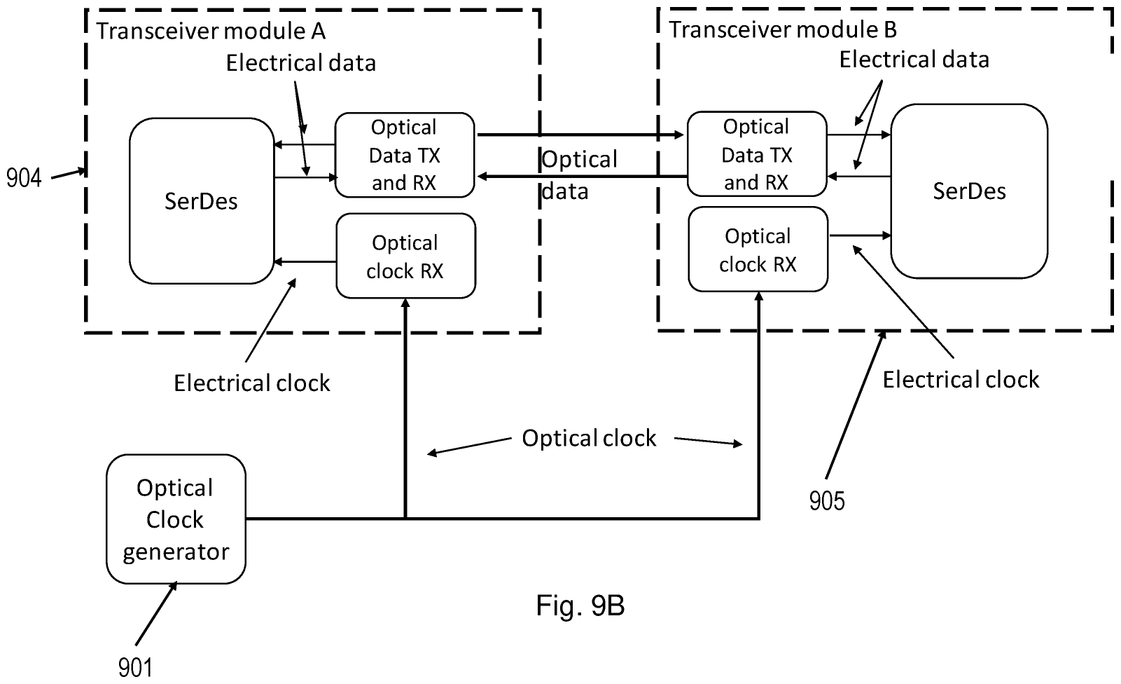

The schematic diagrams in FIG. 9A and FIG. 9B show example implementations of clock signal distribution in accordance with aspects of embodiments. In both examples the optical clock signal is generated by the optical clock generator 901. The FIG. 9A example also includes a transmitter module 902 and a receiver module 903, with an optical connection between the transmitter module 902 and receiver module 903. The FIG. 9B example includes two transceiver modules A and B 904, 905, (both of which include a transmitter and a receiver), with an optical connection between the transceiver modules 904, 905.

An optical clock signal is distributed to the transmitter module 902 and receiver module 903, and to both transceiver modules 904, 905 by the optical clock generator 901. In the examples shown in FIG. 9A and FIG. 9B the optical clock signal has the same frequency as the desired rate of the data link (e.g. 100 GHz for a 100 Gb/s communication).

In the FIG. 9A example, the transmitter module 902 include a digital serializer block, which may be a stand-alone serializer or part of an integrated circuit like an ASIC, FPGA or other circuit. The serializer uses the electrical clock signal obtained from the optical clock signal, at the same frequency as the optical clock signal. The optical clock is converted to an electrical clock by means of a photodetector or other opto-electrical converter, which forms part of the optical clock RX of the transmitter module 902. The signal generated by the serializer is connected using an electrical connection to an optical transmitter that generates the optical data signal used for the communication to the receiver module 903 over the optical connection between the transmitter module 902 and receiver module 903.

The receiver module 903 include two optical-electrical converters: one receives the optical data signal over the optical connection from the transmitter module 902 and converts this optical data signal into an electrical data signal that is fed to a deserializer. The other optical-electrical converter is used to obtain the electrical clock used by the deserializer from the optical clock signal provided by the optical clock generator 901. Similarly to the serializer, the deserializer may be a stand-alone component or part of an integrated circuit like an ASIC, FPGA or other circuit.

The example shown in FIG. 9B is similar to the example in FIG. 9A, except that the FIG. 9B example allows for bidirectional communication between the two transceiver modules (Module A 904 and Module B 905), as each of the two modules includes both an optical transmitter and receiver and also includes a combined serializer and deserializer (a SerDes). Both of the SerDes modules use the electrical clock signal obtained from the optical clock signal, at the same frequency as the optical clock signal, for both serialization and deserialization operations.

In both the example of FIG. 9A and the example of FIG. 9B, all electrical connections are very short (<50 mm), while optical connections can be up to tens or hundreds of meters.

Use of optical clock signals for clock signal distribution can provide several advantages relative to electronic clock signal distribution. Several of the advantages result from the reduced requirement for PLL use. By avoiding the use of multiplied PLL outputs in the clock signal generation, the impact of jitter can be reduced. Further, the avoidance of PLL cascades when generating a clock signal for distribution to several destination reduces power consumption and system management complexity. On the receiving side, as optical clock signals are less susceptible to noise than electronic clock signals and do not typically require regeneration, wander ceases to be an issue, so buffers previously required to counteract wander can be dispensed with and latency can thereby be reduced. Also, aspects of embodiments may be implemented entirely or largely utilising hardware already included in optical transmission systems commonly used for connections between chips (such as USR and XSR interfaces as discussed above), thereby reducing implementation costs.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that incorporates an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A clock signal distribution method, comprising:
transmitting an optical clock signal at a clock frequency via an optical waveguide, wherein the optical clock signal is transmitted separately from optical data transmissions;
receiving the optical clock signal at the same clock frequency using a photodetector;
converting the optical clock signal into an electrical clock signal using the photodetector, wherein the electrical clock signal has the same clock frequency as the optical clock signal; and
transmitting the electrical clock signal at the clock frequency via an electrical connection.

2. The method of claim 1, wherein the optical clock signal is transmitted to a plurality of photodetectors.

3. The method of claim 1, wherein the electrical clock signal is used by an electronic component at the clock frequency.

4. The method of claim 3, wherein the electronic component is a serializer/deserializer, SerDes.

5. The method of claim 1, wherein the optical clock signal is transmitted via the optical waveguide over a distance that is at least 10 times larger than the distance over which the electrical clock signal is transmitted via the electrical connection.

6. The method of claim 1, wherein the optical clock signal is transmitted and received within an integrated circuit, or wherein the optical clock signal is transmitted and received on a single circuit board, or wherein the optical clock signal is transmitted on a first circuit board and received on a second circuit board.

7. (canceled)

8. The method of claim 1, wherein the optical waveguide used to transmit the optical clock signal is used exclusively for the optical clock signal and a further optical waveguide is used for a data signal, or wherein an optical carrier used for the optical clock signal shares an optical waveguide with a further optical carrier used for a data signal, the optical carrier and further optical carrier having different wavelengths.

9. The method of claim 8, wherein a further photodetector, different to the photodetector that receives the optical clock signal, is used to receive the data signal.

10. (canceled)

11. The method of claim 1 wherein the frequency of the optical clock signal is between 20 GHz and 200 GHz

12. The method of claim 11, wherein the frequency of the optical clock signal is between 90 GHz and 110 GHz.

13.-14. (canceled)

15. The method of claim 1, wherein the method is implemented in an Extremely High Frequency, EHF, radio signal generation system.

16. (canceled)

17. A clock signal distribution system for distributing an optical clock signal, the clock signal distribution system comprising an optical clock signal transmitter and an optical clock signal receiver, wherein:
the optical clock signal transmitter is configured to transmit an optical clock signal at a clock frequency via an optical waveguide, wherein the optical clock signal is transmitted separately from optical data transmissions, and
the optical clock signal receiver is configured to: receive the optical clock signal at the same clock frequency using a photodetector; convert the optical clock signal into an electrical clock signal using the photodetector, wherein the electrical clock signal has the same clock frequency as the optical clock signal; and transmit the electrical clock signal at the clock frequency via an electrical connection.

18. The clock signal distribution system of claim 17, comprising a further optical clock signal receiver wherein the optical clock signal transmitter is configured to transmit the optical clock signal to a photodetector in the further optical clock signal receiver.

19. The clock signal distribution system of claim 17, wherein the electrical clock signal is used by an electronic component at the clock frequency.

20. The clock signal distribution system of claim 19, wherein the electronic component is a serializer/deserializer, SerDes.

21. The clock signal distribution system of claim 18, configured such that the optical waveguide over which the optical clock signal is transmitted is at least 10 times longer than the electrical connection over which the electrical clock signal is transmitted.

22. The clock signal distribution system of claim 18, wherein the optical clock signal transmitter and optical clock signal receiver are within an integrated circuit, or wherein the optical clock signal transmitter and optical clock signal receiver are within a single circuit board, or wherein the optical clock signal transmitter is on a first circuit board and the optical clock signal receiver is on a second circuit board.

23. (canceled)

24. The clock signal distribution system of claim 18, configured such that the optical waveguide is used exclusively for the optical clock signal and a further optical waveguide is used for a data signal, or wherein an optical carrier used for the optical clock signal shares the optical waveguide with a further optical carrier used for a data signal, the optical carrier and further optical carrier having different wavelengths.

25.-26. (canceled)

27. The clock signal distribution system of claim 18, wherein the frequency of the optical clock signal is between 20 GHz and 200 GHz.

28. The clock signal distribution system of claim 27, wherein the frequency of the optical clock signal is between 90 GHz and 110 GHz.

29.-30. (canceled)

31. An Extremely High Frequency, EHF, radio signal generation system comprising the clock signal distribution system of claim 18.

32. A node in a telecommunications network comprising the EHF radio signal generation system of claim 31.
